(19) United States
(12) Patent Application Publication
(10) Pub. No.: US 2026/0003570 A1
(43) Pub. Date: Jan. 1, 2026

(54) DATABASE MANAGEMENT APPARATUS AND DATABASE MANAGEMENT METHOD

(71) Applicant: Hitachi, Ltd., Tokyo (JP)

(72) Inventors: Daiki TAKAO, Tokyo (JP); Yoshiki KUROKAWA, Tokyo (JP); Norifumi NISHIKAWA, Tokyo (JP); Kazuhiko MOGI, Tokyo (JP)

(21) Appl. No.: 19/065,195

(22) Filed: Feb. 27, 2025

(30) Foreign Application Priority Data
Jul. 1, 2024 (JP) 2024-106040

(51) Int. Cl. G06F 7/08; G06F 16/22; G06F 16/25

(52) U.S. Cl. CPC G06F 7/08; G06F 16/2264; G06F 16/258

(57) ABSTRACT

A database management apparatus constructs, for each column in input data, a hierarchical histogram of data distribution with respect to the column by repeating division into a prescribed number of areas based on a degree and a base suitable for a multidimensional sorting algorithm and creation of an equal-width histogram as long as an empty bin is present in a histogram, and creates integer value conversion data that maps a value range width of data in the input data to a converted integer value on the basis of the hierarchical histogram. The database management apparatus places the data, which is in the input data, in a database by multidimensionally sorting the input data according to the multidimensional sorting algorithm on the basis of the integer value conversion data of each column.

### CROSS-REFERENCE TO PRIOR APPLICATION

This application relates to and claims the benefit of priority from Japanese Patent Application number 2024-106040, filed on Jul. 1, 2024 the entire disclosure of which is incorporated herein by reference.

### BACKGROUND

The present invention generally relates to data management for databases.

While the amount of data handled by database systems has been increasing year by year due to recent advances in DX, there is a demand for further improvements in the processing speed of analytical queries to speed up decision-making. One approach to this issue is data placement optimization, which aggregates data to be processed in analytical queries, i.e., data with similar values, in physically close locations. By aggregating data required for query processing into a data set that is the unit of reading from a storage, the amount of data read from the storage can be reduced, resulting in rapid processing of analytical queries. In particular, in order to deal with various analytical queries and workloads, optimization that takes into account the balance of values of a plurality of columns on the basis of multidimensional sorting is effective.

The database system disclosed in U.S. Pat. No. 10,114,846 creates a depth-balanced histogram in which the value range width of each bin has been adjusted such that the number of pieces of data allocated is as equal as possible on the basis of values of each column, and converts each piece of data to an integer value on the basis of the bin id to which each piece of data is allocated. The database system then performs data placement optimization on the basis of converted integer values, and automatically updates the histogram in accordance with changes in the distribution of data stored in a database.

### SUMMARY

The unit of data (data set) read from a database is called a “segment” for convenience. One of elements for enhancing the performance of a database system is division of data stored in a database. Specifically, for example, if data to be processed by a query is aggregated in the same segment, the number of segments for which reading can be omitted increases, and as a result, improvement of reading performance is expected. Multidimensional sorting can be used to divide data.

Multidimensional sorting generally supports only integer values. Therefore, in order to handle data (for example, real numbers and character strings) other than integer values, it is necessary to convert the data to integer values in advance.

In a method of simply converting each value to an integer value using only upper bits of each value, if there is a bias in input data such as outliers, the cardinality of a converted integer value decreases, and as a result, the granularity of sorting becomes coarse, that is, sorting can only be performed at a coarse level. Therefore, pieces of data having significantly different values are aggregated in the same segment in the storage, which results in a problem of an increase in the amount of data read from the storage.

On the other hand, in U.S. Pat. No. 10,114,846, value range widths of bins are adjusted such that the numbers of pieces of data in the respective bins become equal. Accordingly, there is a risk that data having significantly different values will be allocated to the same bin, that is, the same integer value will be allocated to data having significantly different values. This results in a problem that data having significantly different values are aggregated in nearby locations, which results in an increase in the amount of data read from the storage.

An object of the present invention is to maintain a high cardinality of converted integer values even if there is a bias in a data distribution and to prevent data having significantly different values from being aggregated in nearby locations in a storage.

A database management apparatus constructs, for each column in input data, a hierarchical histogram of data distribution with respect to the column by repeating division into a prescribed number of areas based on a degree and a base suitable for a multidimensional sorting algorithm and creation of an equal-width histogram as long as an empty bin is present in a histogram, and creates integer value conversion data that maps a value range width of data in the input data to a converted integer value on the basis of the hierarchical histogram. The database management apparatus places the data, which is in the input data, in a database by multidimensionally sorting the input data according to the multidimensional sorting algorithm on the basis of the integer value conversion data of each column.

According to the present invention, even if there is a bias in a data distribution, a high cardinality of converted integer values can be maintained, and data having significantly different values can be prevented from being aggregated into the same database segment.

### BRIEF DESCRIPTION OF THE DRAWINGS

FIG. 1 is a configuration diagram of a database system.

FIG. 2 is a configuration diagram of physical data in a storage.

FIG. 3 is a configuration diagram of range indices.

FIG. 4 is a detailed explanatory diagram of each element of the database system.

FIG. 5 is a flowchart showing processing of an integer value conversion unit.

FIG. 6 is a diagram showing an example of the operation of the integer value conversion unit.

### DESCRIPTION OF EMBODIMENTS

In the following description, an “interface apparatus” may be one or more interface devices. The one or more interface devices may be at least one of the following.
An input/output (I/O) interface apparatus which is one or more I/O interface devices. An I/O interface device is an interface device for at least one of an I/O device and a remote display computer. The I/O interface device for a display computer may be a communication interface device. The at least one I/O device may be a user interface device, for example, either an input device such as a keyboard and pointing device, or an output device such as a display device.
A communications interface apparatus which is one or more communication interface devices. The one or more communication interface devices may be one or more homogeneous communication interface devices (e.g., one or more network interface cards (NICs)) or two or more heterogeneous communication interface devices (e.g., an NIC and a host bus adapter (HBA)).

In addition, in the following description, a “memory” may be one or more memory devices which are an example of one or more storage devices, and may typically be a primary storage device. At least one memory device in a memory may be a volatile memory device or a non-volatile memory device.

In addition, in the following description, a “persistent storage apparatus” may be one or more persistent storage devices which are an example of one or more storage devices. The persistent storage device may typically be a non-volatile storage device (e.g., an auxiliary storage device), and specifically, may be, for example, a hard disk drive (HDD), a solid state drive (SSD), a non-volatile memory express (NVME) drive, or a storage class memory (SCM).

Furthermore, in the following description, a “storage apparatus” may be at least a memory of a memory and a persistent storage device.

In addition, in the following description, a “processor” may be one or more processor devices. At least one processor device may typically be a microprocessor device such as a central processing unit (CPU), but may also be other types of processor devices such as a graphics processing unit (GPU). At least one processor device may be a single core or a multi-core. At least one processor device may be a processor core. At least one processor device may be a processor device in the broad sense, such as a circuit that is a collection of gate arrays (e.g., a field-programmable gate array (FPGA), a complex programmable logic device (CPLD), or an application specific integrated circuit (ASIC)) that performs some or all of processing using a hardware description language.

Furthermore, in the following description, a function is sometimes described using the expression “yyy unit,” but a function may be realized by one or more computer programs being executed by a processor, realized by one or more hardware circuits (e.g., FPGAs or ASICs), or realized by a combination thereof. When a function is realized by a program being executed by a processor, specified processing is performed using a storage apparatus and/or an interface apparatus, etc., as appropriate, and thus the function may be at least a part of the processor. Processing described using a function as a subject may be processing performed by a processor or an apparatus having the processor. A program may be installed from a program source. The program source may be, for example, a program distribution computer or a computer-readable storage medium (e.g., a non-transient storage medium). The description of each function is an example, and a plurality of functions may be combined into one function or one function may be divided into a plurality of functions.

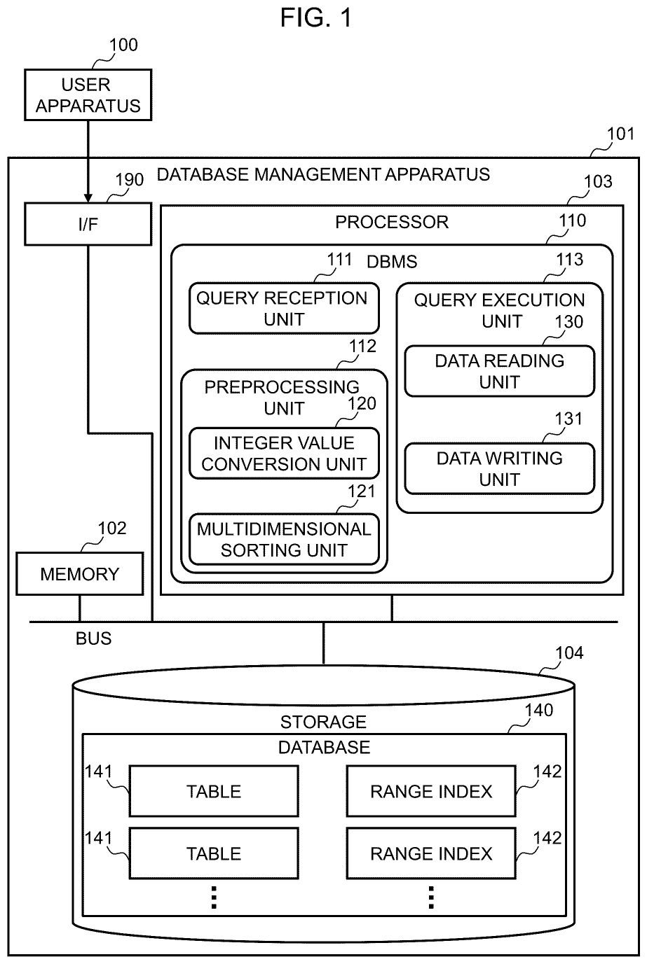

Hereinafter, an embodiment of the present invention will be described with reference to FIG. 1 to FIG. 6.

FIG. 1 is a configuration diagram of a database system according to an embodiment of the present invention.

In the figure, 100 is a user apparatus, 101 is a database management apparatus, 102 is a memory, 103 is a processor, 104 is a storage, 110 is a database management system (DBMS), 111 is a query reception unit, 112 is a preprocessing unit, 113 is a query execution unit, 120 is an integer value conversion unit, 121 is a multidimensional sorting unit, 130 is a data reading unit, 131 is a data writing unit, 140 is a database, 141 is a table, 142 is a range index, and 190 is an interface apparatus. The table 141 and the range index 141 are one or more components of the databases 140.

The database system includes the user apparatus 100 and the database management apparatus 101. The user apparatus 100 may be a client, and the database management apparatus 101 may be a server.

The user apparatus 100 sends a query including an instruction to write data to the DBMS 110 and/or an instruction to read data to the database management apparatus 101. The user apparatus 100 may be a physical computer or a logical computer (e.g., a virtual machine). The user apparatus 100 is an example of a query source. The query source may be a program such as an application program executed in the user apparatus 100 or the database management apparatus 101.

The database management apparatus 101 includes the interface apparatus 190, the memory 102, the processor 103, and the storage 104, which are connected via a bus. At least the memory 102 of the memory 102 and the storage 104 is an example of a storage apparatus. The storage 104 is an example of a persistent storage apparatus.

The interface apparatus 190 communicates with the user apparatus 100 via a communication network such as the Internet, for example. Specifically, for example, a query is received through the interface apparatus 190, and a response (for example, read data) to the query is sent to the user apparatus 100 through the interface apparatus 190.

The memory 102 is, for example, a dynamic random access memory (DRAM), and stores some data of the table 141 and the range index 142 handled by the DBMS 110.

The processor 103 may be a central processing unit of the database management apparatus 101 and executes the DBMS 110.

The storage 104 may be, for example, a solid state drive (SSD) or an array of SSDs. The table 141 and the range index 142 are stored in the storage 104. The storage 104 may be an external storage of the database management apparatus 101.

The DBMS 110 includes the query reception unit 111, the preprocessing unit 112, and the query execution unit 113. The DBMS 110 reads/writes data from/to the database 140 (the table 141 and the range index 142) on the basis of a query provided by the user apparatus 100.

The query reception unit 111 receives a query from the user apparatus 100, requests that the query execution unit 113 process the query, formats the result obtained from the query execution unit 113, and sends the formatted result to the user apparatus 100.

The preprocessing unit 112 includes the integer value conversion unit 120 and the multidimensional sorting unit 121. The preprocessing unit 112 performs multidimensional sorting of input data to the database system on the basis of values of a plurality of columns.

The query execution unit 113 includes the data reading unit 131 and the data writing unit 132. The query execution unit 113 reads/writes data from/to the memory 102 and the storage 104 on the basis of data multidimensionally sorted by the preprocessing unit 112 and a query processing request from the query reception unit 111.

As preprocessing for multidimensional sorting, the integer value conversion unit 120 creates a conversion table for conversion from values of each column to integer values such that input data with a bias in distribution, such as outliers, can be multidimensionally sorted in a balanced manner across a plurality of columns.

The multidimensional sorting unit 121 performs multidimensional sorting of input data for the database system in a balanced manner across a plurality of columns on the basis of the conversion table to integer values created by the integer value conversion unit 120.

Input data provided by the user apparatus 100 is multidimensionally sorted by the preprocessing unit 112 and then written to the memory 102 and the storage 104 by the data writing unit 132, and thus data having similar values in a plurality of columns tends to be placed in physically nearby locations (for example, in the same segment).

Furthermore, by creating the conversion table for conversion from values of each column to integer values in the integer value conversion unit 120 while considering a bias in the distribution of the input data before sorting by the multidimensional sorting unit 121, multidimensional sorting can be applied to data other than integer values, and degradation of sorting performance due to a bias in data distribution such as outliers can be curbed.

As a result, when a query provided by the user apparatus 100 is executed by the query execution unit 113, unnecessary data reading by the data reading unit 131 is curbed, and thus the DBMS 110 can reduce a query response time.

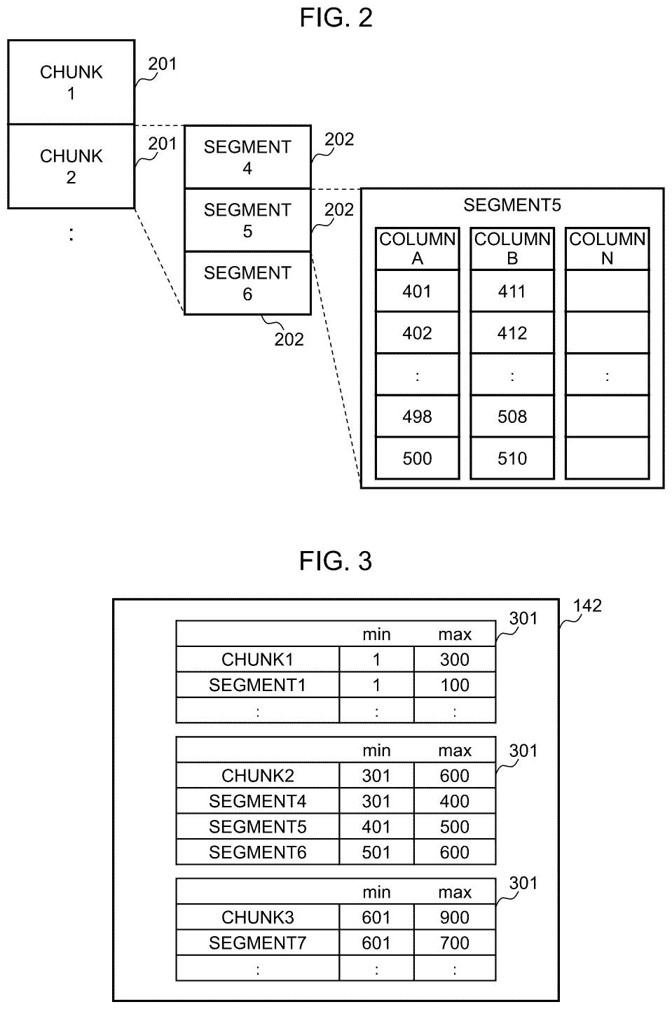

FIG. 2 is a configuration diagram physical data in the storage 104.

Data of the table 141 is distributed to one or more chunks 201 and placed therein. The data of chunks 201 is distributed to one or more segments 202 and placed therein. In addition, in the segments 202, some of the data of table 141 is aggregated and held on a column-by-column basis, and thus data reading for a specific column can be performed efficiently. The segment 202 is the unit of reading.

FIG. 3 is a configuration diagram of the range index 142.

The range index 142 manages information on the value range width of the data included in the chunks 201 and the segments 202 on a column-by-column basis.

In the figure, 301 represents a range index for column A. For example, the range index 301 for column A is present for each chunk, and according to the range index 301 corresponding to chunk 2, the minimum value of the values held by column A is “301” and the maximum value is “600.” Accordingly, in chunk 2, only data in the range [301, 600] (i.e., the range equal to or greater than 301 and equal to or smaller than 600) is present as the values of column A. Therefore, in data read processing that targets a range that does not overlap with this value range width, the query execution unit 113 can determine that it is not necessary to read the data of chunk 2 from the storage 104, and can skip reading the data.

That is, in such a range index 142, the smaller the value range width of each chunk 201, the higher the possibility of skipping reading of the chunk 201. Therefore, the more the preprocessing unit 112 can aggregate data with similar values in a physically closer location, the shorter the query response time in the DBMS 110 can be.

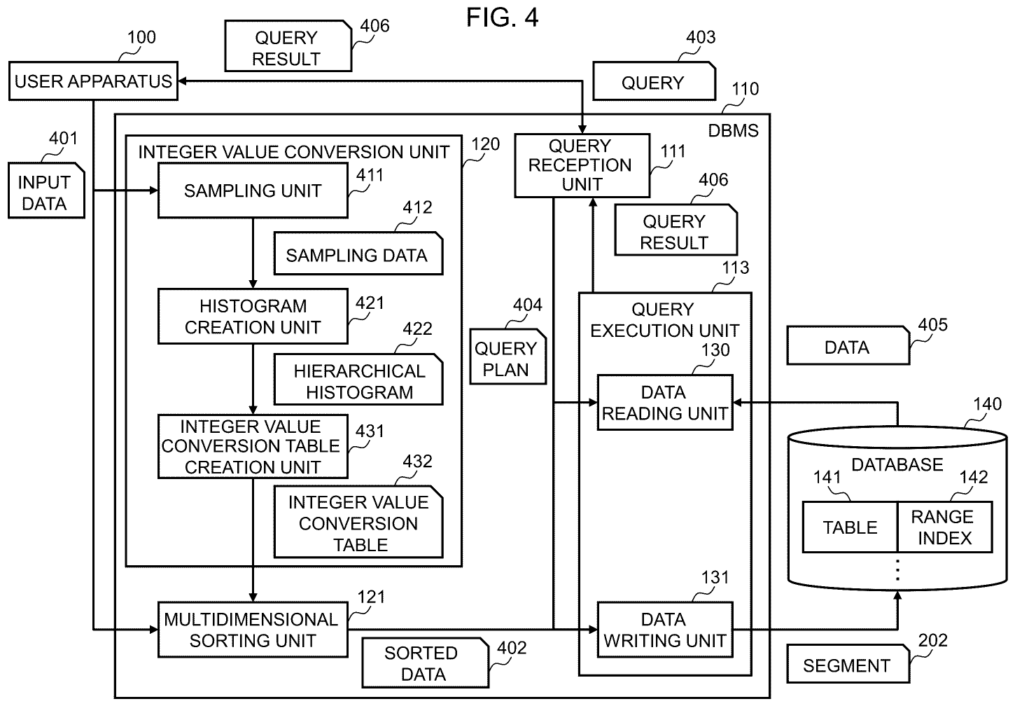

FIG. 4 is a detailed explanatory diagram of each element of the database system. In the figure, the same numbers are used for components that have been previously described, and description thereof will be omitted.

In the figure, 401 is input data, 402 is sorted data, 403 is a query, 404 is a query plan, 405 is data, 406 is a query result, 411 is a sampling unit, 412 is sampling data, 421 is a histogram creation unit, 422 is a hierarchical histogram, 431 is an integer value conversion table creation unit, and 432 is an integer value conversion table.

The input data 401 is data provided as input from the user apparatus 100 to the DBMS 110. The input data 401 may be in any file format, including comma separated values (CSV). The input data 401 may be a large amount of data input at regular intervals, such as every hour. Further, the input data 401 may be multidimensional data that includes data of a plurality of columns and has weak correlation between columns.

The sorted data 402 is data resulting from multidimensional sorting of the input data 401 performed by the multidimensional sorting unit 121 with reference to the integer value conversion table 432.

The query 403 is a query provided from the user apparatus 100 to the DBMS 110. For example, an analysis query using range search on various columns may be provided from the user apparatus 100.

The query plan 404 is a query execution plan output as a result of interpreting and optimizing the query 403 in the query reception unit 111, and is sent to the query execution unit 113.

The data 405 is data read from the storage 104 by the data reading unit 130 in order to execute the query plan 404.

The query result 406 is a result of executing the query plan 404 in the query execution unit 113, and is sent to the user apparatus 100 via the query reception unit 111.

The sampling unit 411 is a function that performs processing first in the integer value conversion unit 120. The sampling unit 411 outputs the sampling data 412 by randomly extracting data from the input data 401. This reduces the processing cost of the histogram creation unit 421 and improves the processing speed of the integer value conversion unit 120 as a whole. Here, the number of pieces of data to be sampled may be automatically obtained, for example, from Sturges's formula or the confidence interval formula, which represents the ideal balance between the number of divisions of each column and the number of pieces of sampling data, or may be directly designated by a user on the basis of service level agreement (SLA) for the application.

As described above, the sampling data 412 is data randomly extracted from the input data 401 by the sampling unit 411.

The histogram creation unit 421 is a function that executes processing after the sampling unit 411. The histogram creation unit 421 creates a hierarchical histogram 422 by performing the following for each column of the sampling data 412.
(Procedure 1) An equal-width histogram is created for an area of interest.
(Procedure 2) If there is an empty bin to which no data is allocated, the area is divided starting from the empty bin, and then the area with the largest value range width is divided into two equal parts until the number of areas reaches a specified number.
(Procedure 3) The above (procedure 1) and (procedure 2) are repeated recursively for each of the obtained areas until they become indivisible.

However, the “specified number of the number of areas” is set to an appropriate value depending on the algorithm used by the multidimensional sorting unit 121, such as 2 to the power of n in the case of Hilbert sorting. Recursively dividing into a number of areas appropriate for the multidimensional sorting algorithm increases the possibility that data with similar values will be allocated to the same area or the same bin, that is, there is an effect that data with similar values as a result of sorting are more likely to be placed in closer locations.

As described above, the hierarchical histogram 422 is a histogram created by the histogram creation unit 421.

The integer value conversion table creation unit 431 is a function that executes processing after the histogram creation unit 421. The integer value conversion table creation unit 431 creates the integer value conversion table 432 that maps the value range width of original data to be converted to integer values after conversion on the basis of the hierarchical histogram 422. Since the histogram creation unit 421 creates the hierarchical histogram 422 on the basis of the sampling data 412 instead of the entire input data 401, there may be a value range width where no bin of the hierarchical histogram 422 is present, and as a result, there is a risk that some data of the input data 401 cannot be converted to integer values. Therefore, the integer value conversion table creation unit 431 adjusts the value range width of each bin such that all data of the input data 401 can be converted to integer values, and assigns integer values to each bin such that data that take similar values during multidimensional sorting is likely to be allocated to the same area.

As described above, the integer value conversion table 432 is a table created by the integer value conversion table creation unit 431, and is a table that maps the value range width of the original data to be converted to integer values after conversion.

The multidimensional sorting unit 121 sorts the input data 401 while referring to this integer value conversion table 432, thereby aggregating data with similar values into closer locations. Then, by writing the sorted data 402 to the memory 102 and the storage 104 through the data writing unit 132, data with similar values is more likely to be placed in the same segment 202. As a result, when a query provided by the user apparatus 100 is executed by the query execution unit 113, unnecessary data reading by the data reading unit 131 can be curbed, and the query response time of the DBMS 110 can be reduced.

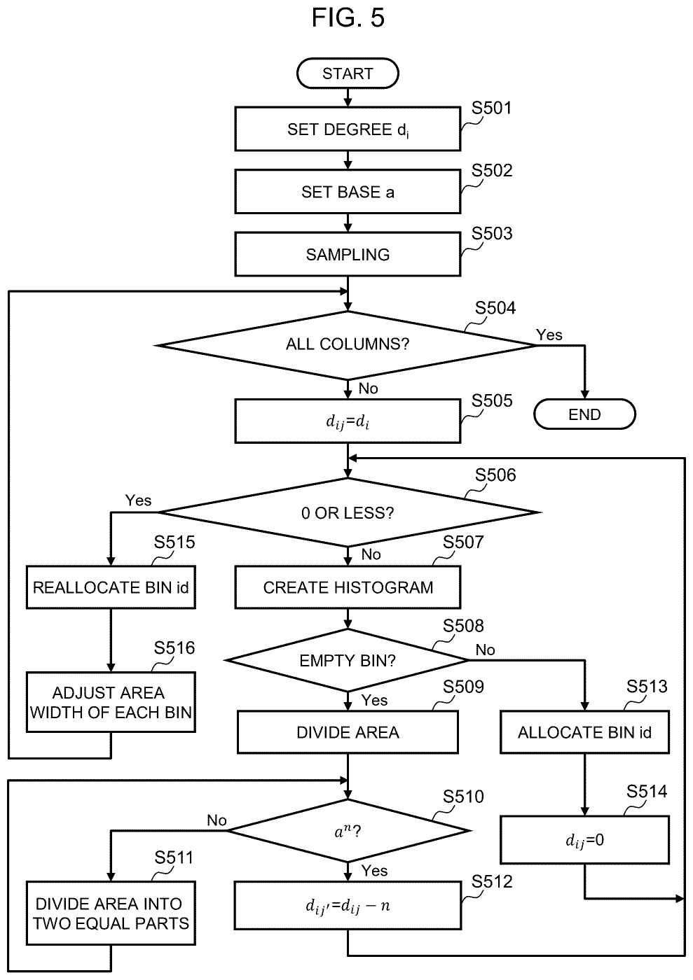

FIG. 5 is a flowchart showing processing of the integer value conversion unit 120.

First, the sampling unit 411 receives information on the degree dᵢ of each column i from the user apparatus 100 in step S501. The column i is divided into 2\hat{ }(dᵢ) areas (i.e., 2 to the power of dᵢ areas). The information on the degree dᵢ of each column i may be associated with the input data 401.

In the following step S502, the sampling unit 411 sets an appropriate base a according to an algorithm (multidimensional sorting algorithm) used in the multidimensional sorting unit 121. For example, a=2 in the case of Hilbert sorting.

In the following step S503, the sampling unit 411 outputs sampling data 412 by randomly extracting data from the input data 401. The sampling data 412 may include data randomly extracted for each column.

In the following step S504, the histogram creation unit 421 determines whether histograms have been created for all columns of the sampling data 412. If histograms have been created for all columns (S504: Yes), processing ends. If there are columns for which histograms have not yet been created (S504: No), the histogram creation unit 421 designates one of the columns as a column of interest i, and processing proceeds to step S505.

In step S505, the histogram creation unit 421 initializes the current degree d_{i,j} to dᵢ as preprocessing for creating a histogram for area j of the current column i of interest. However, in the initial state, only area 0 is present, and the value range width thereof is equal to the value range width of column i. The degree dᵢ may be the same or different for each column.

In the following step S506, the histogram creation unit 421 determines whether the current degree d_{i,j} of all areas j has become 0. If the degree d_{i,j} of the entire area j has become 0 (S506: Yes), the histogram creation unit 421 determines that creation of the histogram for the column i of interest complete, and processing proceeds to step S515. If there are any areas for which the degree d_{i,j} is not 0 (S506: No), the histogram creation unit 421 designates one of those areas as an area j of interest, and processing proceeds to step S507.

In step S507, the histogram creation unit 421 creates an equal-width histogram that divides the area j of interest into a\hat{ }(d_{i,j}) equal parts. “a\hat{ }(d_{i,j})” means a to the power of d_{i,j}. Therefore, for example, when a=2 and d_{i, j}=3, an equal-width histogram that divides the area j of interest into eight equal parts (23=8) is created. The created equal-width histogram has a\hat{ }(d_{i,j}) bins.

In the following step S508, the histogram creation unit 421 determines whether there is a bin to which no data is allocated (i.e., an empty bin) among the created a\hat{ }(d_{i,j}) bins. If there is even one empty bin (S508: Yes), further area division is necessary, and thus processing proceeds to step S509. If there is no empty bin (S508: No), further area division is not necessary, and thus processing proceeds to step S513.

In step S509, the histogram creation unit 421 creates a cluster area of bins in which data is present, starting from an empty bin. A “cluster area” is a cluster of one or more consecutive bins in which data is present. That is, the histogram creation unit 421 deletes empty bins by dividing a histogram into a plurality of cluster areas. By deleting empty bins in this way, it is possible to reduce the number of integer values that are not allocated to any data, that is, to maintain a high cardinality of converted integer values. This has the effect of making it possible to refine the granularity of sorting during multidimensional sorting (to sort by taking into account smaller value differences).

In the following step S510, the histogram creation unit 421 judges whether the number of areas (the number of cluster areas) obtained as a result of division is equal to aⁿ. Here, n is an arbitrary integer that satisfies 1≤n≤d_{i,j}. If the number of areas is equal to an (S510: Yes), no further division is necessary, and thus processing proceeds to step S512. If the number of areas is not equal to an (S510: No), further area division is necessary, and thus processing proceeds to step S511. By controlling the number of divided areas to always be an in this way, there is an effect that data with similar values are more likely to be placed in closer locations.

In step S511, the histogram creation unit 421 divides the area with the largest area width in the set of partial areas obtained by dividing the area j of interest into two equal parts. Thereafter, processing proceeds to step S510.

In step S512, the histogram creation unit 421 reduces by n the degree d_{i,j′} of each partial area j′ created by dividing the area j of interest. Thereafter, processing proceeds to step S506.

In step S513, the histogram creation unit 421 allocates a bin ids to respective bins of the histogram created for the area j of interest such that they are equally distributed in the range of [0, a\hat{ }(d_{i,j})−1] (i.e., the range equal to or greater than 0 and equal to or smaller than a\hat{ }(d_{i,j})−1). If this processing is not performed, integer values allocated to the data in column i will be biased toward [0, a\hat{ }(d_{i,j}−1)−1], and many of the values of [a\hat{ }(d_{i,j}−1), a\hat{ }(d_{i,j})−1] will not be used. As a result, data to which integer values of [a\hat{ }(d_{i,j}−1), a\hat{ }(d_{i,j})−1] have been allocated will have difficulty evaluating the values of column i relative to other columns, resulting in a sorting result that is biased toward a specific column. On the other hand, equalizing the bin ids in step S513 has the effect of allowing values of a plurality of columns to be sorted in a balanced manner during multidimensional sorting. Note that “a\hat{ }(d_{i,j}−1)” means a to the (d_{i,j}−1)-th power. For example, if d_{i,j} is 3, “a\hat{ }(d_{i,j}-1)” means a to the (3−1)-th power, that is, a².

In the following step S514, the histogram creation unit 421 sets the degree d_{i,j} of the area j of interest to 0. Thereafter, processing proceeds to step S506.

In step S515, the integer value conversion table creation unit 431 updates the bin ids of the bins of the hierarchical histogram 422 for column i created by processing so far to values obtained by combining ids of areas and bins in a-ary notation in order from a higher tier and converting the same to decimal numbers. This has the effect that, during multidimensional sorting, evaluation is performed in order from the area id of the higher tier, and data with significantly different values is less likely to be mixed together by sorting.

In the following step S516, the integer value conversion table creation unit 431 adjusts the value range width of each bin such that there is no empty area in the hierarchical histogram for column i for which the bin ids have been reset. Thereafter, processing proceeds to step S504. This is processing for, in a case where some data in the input data 401 is likely to be allocated to even areas with empty bins in the sampling data 412, allocating data in the input data 401 to the nearest bin in the hierarchical histogram 422. Specifically, processing is as follows. First, the area of bin k in the hierarchical histogram 422 is represented as [minₖ, maxₖ) (i.e., the range of bin k is equal to or greater than minₖ and less than maxₖ). If maxₖ and minₖ+1 do not match, the integer value conversion table creation unit 431 updates maxₖ and minₖ+1 to maxₖ+ (minₖ+1-maxₖ)/2. In addition, the integer value conversion table creation unit 431 sets the minimum value of bin 0 (the bin with bin id=0) to −∞ and the maximum value of bin 2\hat{ }(dᵢ)−1 (the bin with bin id=2\hat{ }(dᵢ)−1) to ∝. This makes it possible to uniquely allocate an integer value to any value (data) of the input data 401 that is not present in the sampling data 412.

The hierarchical histogram of column i obtained as a result of processing in step S516 functions as an integer value conversion table 432 that maps the value range width of column i to converted integer values. This integer value conversion table 432 makes it possible to allocate integer values to data that take arbitrary values such that data that take similar values during multidimensional sorting can be easily aggregated into the same segment.

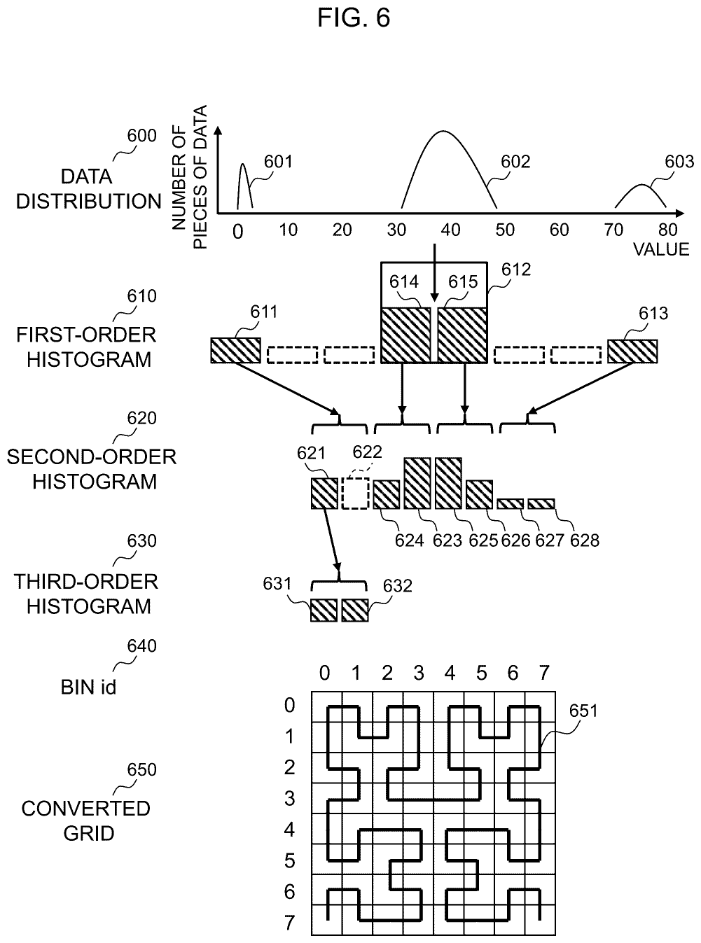

FIG. 6 is a diagram showing an example of the operation of the integer value conversion unit 120.

As a premise, it is assumed that the degree dᵢ=3 of each column i is designated in step S501. In addition, since the multidimensional sorting unit 121 uses Hilbert sorting, it is assumed that the base a=2 is set in step S502.

Then, in the following step S503, it is assumed that the sampling unit 411 randomly extracts data from the input data 401, thereby obtaining sampling data 412 such that column 1 has a data distribution 600. In the graph of the data distribution 600, the horizontal axis corresponds to the values of column 1, and the vertical axis corresponds to the number of pieces of data that take respective values. It is assumed that, in addition to the constant value set 602 at the center of the graph, there are outlier sets 601 and 603 at both ends of the graph.

At this time, since the histogram creation unit 421 has not yet created a histogram for column 1 (i=1), the histogram creation unit 421 sets column 1 as a column of interest, and processing proceeds from step S504 to step S505. In step S505, the histogram creation unit 421 sets the degree d_{1,0}=3 for the initial area 0 (j=0) of column 1 and sets area 0 as an area of interest (i.e., j=0), and processing proceeds from step S506 to step S507.

Next, in step S508, the histogram creation unit 421 creates a first-order equal-width histogram 610 that divides area 0 into 23=8 equal parts. Since there is an empty bin in the first-order equal-width histogram 610, processing proceeds from step S508 to step S509. In step S509, the histogram creation unit 421 divides the first-order equal-width histogram 610 into three areas, an area 611 of [0, 10), an area 612 of [30, 50), and an area 613 of [70, 80), starting from the empty bin. In other words, the histogram creation unit 421 defines one or more areas from the first-order equal-width histogram 610 having an empty bin. For each of the one or more defined areas, the value range (value range width) of the area is equal to or greater than the minimum value and less than the maximum value of one or more consecutive bins having data.

The number of areas obtained from the first-order equal-width histogram 610 is 3, which does not satisfy 2n (where 1≤n≤3), and thus processing proceeds from step S510 to step S511. In step S511, the histogram creation unit 421 equally divides the area 612 of [30, 50), which has the largest area width, into two. Accordingly, two areas of an area 614 of [30, 40) and an area 615 of [40, 50). Processing proceeds again to step S510.

As a result, the number of areas becomes 4, which satisfies 2ⁿ (where n=2), and thus processing proceeds from step S510 to step S512. In step S512, the histogram creation unit 421 sets the degree d_{i,j′} of each area to d_{1,0}−n=3−2=1, and processing proceeds to step S506.

The processing of step S506 and the following processing are similarly applied to each of the areas 611, 614, 615, and 613, completing a second-order histogram 620. Since the degree d_{i,j′} of each area is set to 1, each area is equally divided into 2 (=21) as shown in FIG. 6. Here, no further division is performed in each of the areas 614, 615, and 613 since no empty bins are created. However, in the area 611, the area 622 of [5, 10) has become empty (i.e., an empty bin has been created), and thus processing from step S506 and the following processing need to be applied again to the area 621 of [0, 5). As a result, a third-order histogram 630 is generated. The third-order histogram 630 has an area 631 of [0, 2.5) and an area 632 of [2.5, 5). Since neither of these areas 631 and 632 is empty, no further division is performed.

Thereafter, in step S515, the integer value conversion table creation unit 431 sets a bin id 640 for the hierarchical histogram 422 for column 1 obtained by the above processing. For example, if the area 623 of [35, 40) in the second-order equal-width histogram 620 is focused, processing is as follows. That is, this area 623 of interest belongs to the second area 614 of the four areas 611, 614, 615, and 613 in the first-order equal-width histogram 610, and this second area 614 has an area id=01. Further, since the area 623 of interest is the second bin in the area 614 in the second-order equal-width histogram 620, bin id=1. Therefore, the bin id for the area 623 of interest is 011 in binary notation, that is, 3 in decimal notation. Referring to FIG. 6, in the hierarchical histogram 422 (histograms 610, 620, and 630), there are eight areas (areas 631, 632, 624, 623, 625, 626, 627, and 628 in ascending order of min), and therefore the bin ids for these eight areas are 0 to 7 in decimal notation. The bin id indicates the number of the bin from the side with the smallest min in the hierarchical histogram 422.

Finally, in step S516, the integer value conversion table creation unit 431 adjusts the value range width of each bin such that there are no empty bins in the hierarchical histogram 422 for column 1. For example, the original areas with bin id=1 and 2 are [2.5, 5) and [30, 35), respectively, and since [5, 30) is empty, the integer value conversion table creation unit 431 updates the same to max₁=min₂=5+(30−5)/2=17.5. That is, the value range widths of the areas (bins) with bin id=1 and 2 after adjustment become [2.5, 17.5) and [17.5, 35), respectively.

The hierarchical histogram 422 created by the above processing functions as the integer value conversion table 432 for column 1, and converts any data in column 1 into any integer value between [0, 7]. By similarly converting the values of the other columns to integer values, any data can be uniquely mapped onto a converted grid 650. One axis of the grid 650 corresponds to the bin ids 0 to 7 assigned to the bins of the hierarchical histogram 422 for column 1, and another axis of the grid 650 corresponds to the bin ids assigned to the bins of the hierarchical histogram for another column. By the multidimensional sorting unit 121 performing multidimensional sorting based on the grid 650 (for example, by arranging data along a Hilbert curve 651), data having similar values can be aggregated to nearby locations while taking into account the values of a plurality of columns in a balanced manner. In particular, by dividing an area into an parts at the time of creating a histogram for each tier, data belonging to the same set among data sets 601, 602, and 603 can be aggregated as much as possible, which has the effect of reducing the value range width of the range index of each segment.

Although one embodiment has been described above, this is merely an example for the purpose of explaining the present invention, and is not intended to limit the scope of the present invention to only this embodiment. The present invention can be embodied in various other forms.

The above description can be summarized as follows, for example. The summary below may include supplementary description and description of modified examples of the above description.

A database management apparatus (e.g., the database management apparatus 101) includes an integer value conversion unit (e.g., the integer value conversion unit 120) and a multidimensional sorting unit (e.g., the multidimensional sorting unit 121). The integer value conversion unit constructs, for each column in input data (e.g., the input data 401) having a plurality of columns, a hierarchical histogram (e.g., the hierarchical histogram 422) of data distribution with respect to the column by repeating division into a prescribed number of areas based on a degree and a base suitable for a multidimensional sorting algorithm and creation of an equal-width histogram as long as an empty bin is present in a histogram, and creates integer value conversion data (e.g., the integer value conversion table 432) that maps a value range width of data in the input data to a converted integer value on the basis of the hierarchical histogram. The multidimensional sorting unit places the data in the input data in a database (e.g., the database 140) from which data is read in units of segment by multidimensionally sorting the input data according to the multidimensional sorting algorithm on the basis of the integer value conversion data of each column. This makes it possible to maintain a high cardinality of converted integer values even if there is a bias in the data distribution, and to prevent data having significantly different values from being aggregated into the same database segment.

For each column, the converted integer value may be a bin id of any bin in the hierarchical histogram of the column. The integer value conversion unit may assign bin ids of bins in the hierarchical histogram equally in the range equal to or greater than a first integer value and equal to or smaller than a second integer value. The first integer value may be a predetermined integer value (e.g., 0). The second integer value may be based on the base and a given degree of the column. Accordingly, it is expected that bin ids will allow for balanced sorting across a plurality of columns. That is, conversion to integer values that balance the granularity of sorting among columns to be sorted is expected. For example, for each area, the first integer value may be 0, and the second integer value may be a base \hat{ } (the degree of the area−1).

(A) to (C) may be performed for each column. An example of (A) is S507 in FIG. 5. An example of (B) is S508 in FIG. 5. An example of (C) is steps S509 to S511 in FIG. 5. This is expected to keep the number of empty bins small as much as possible while keeping the value range width of each segment small.
(A) If there is an area j related to the column and having a degree of 1 or more, the integer value conversion unit creates, for the area j, an equal-width histogram by dividing the area j into X equal parts (X is the base \hat{ }, the degree of the area j).
(B) The integer value conversion unit determines whether there is an empty bin in the equal-width histogram.
(C) If a result of determination in (B) is true, the following (c1) and (c2) are performed.
(c1) The integer value conversion unit divides the equal-width histogram into a plurality of areas j′ by removing empty bins from the equal-width histogram. Each of the plurality of areas j′ is composed of one or more consecutive bins in which data is present.
(c2) The integer value conversion unit reduces, for each of the plurality of areas j′, the degree of the area j′ from the degree of the original area j of the area j′, and then performs (A) on each area j′ as the area j.

In (c1), that is, the integer value conversion unit may determine whether the number of areas j′ is the n-th power of the base (n is an integer equal to or greater than 1 and equal to or less than the degree of the original area j of the areas j′) in the following (c11). An example of (c11) may be S510 in FIG. 5. If the number of areas j′ is the n-th power of the base, for each of the plurality of areas j′, the integer value conversion unit may reduce the degree of the area j′ by n from the degree of the original area j of the area j′ in (c2). This allows area division to end at an appropriate time, and thus it is expected that the value range width of each segment can be appropriately kept small while reducing the number of empty bins as much as possible.

If the number of areas j′ is not the n-th power of the base, the integer value conversion unit may further divide an area j′ with the largest area width into two equal areas j′ (for example, perform S511 in FIG. 5) and perform (c11). This makes it possible to keep the number of areas j′ to the n-th power of the base while keeping the range width of each segment small.
(D) may be performed for each column. An example of (D) is S513 and S514 in FIG. 5. This equalizes bin ids, making it possible to sort the values of a plurality of columns in a balanced manner during multidimensional sorting. (D) If the determination result in (B) is false, the following (d1) and (d2) are performed.
(d1) The integer value conversion unit allocates equal integers in the range equal to or greater than 0 and equal to or smaller than the base\hat{ } (the degree of the area j−1) as bin ids to a plurality of bins in the equal-width histogram.
(d2) The degree of the area j is changed to 0.

For each column, if the degrees of all the areas j related to the column are 0 or less, the integer value conversion unit may update the bin id of a bin in the hierarchical histogram of the column to a value obtained by combining bin ids in the area including the bin in order from the bin id of a higher tier that has the original area of the bin in a-ary notation, and converting the combined value to a decimal value (for example, S515 in FIG. 5). This allows area ids of the higher tier to be evaluated in order during multidimensional sorting, and it is expected that data having significantly different values will not be mixed together by sorting. For example, in a hierarchical histogram, the bin id of a bin in the lowest tier may be determined as follows. The bin id (is in a-ary notation) in the area that has the bin and the id (ID in a-ary notation) of the area of the higher tier to which the bin belongs are combined. The combined a-ary id is converted to a decimal id. The converted id is the bin id in the hierarchical histogram.

If there is an empty area in the hierarchical histogram, the integer value conversion unit may adjust the value range width of each bin in the hierarchical histogram such that the empty area disappears (for example, S516 in FIG. 5). This allows a unique integer value to be allocated to data in the input data.

For each column, the integer value conversion unit may obtain sampling data (for example, sampling data 412) by randomly extracting data from the input data. A hierarchical histogram of a data distribution regarding the column may be a histogram created from the sampling data. The number of pieces of data randomly extracted may be based on the degree of the column. This allows the amount of calculation required to create the histogram to be appropriately reduced. For example, the sampling data 412 may include data randomly extracted for each column. If a degree d is given as a parameter related to the number of divisions of the column and ad bins are created for the column, the range of integer values allocated to the column (range of bin ids) may be [0, a^{d}−1]. That is, consecutive integer values from 0 to a^{d}−1 may be allocated to the a^{d} bins obtained for the column. k=1+ logₐm may be used. k may be the number of bins. m may be the number of samples (the number of pieces of data to be randomly extracted). a is a base suitable for the multidimensional sorting algorithm, and may be, for example, “2.” m=a^{k-1}=a\hat{ }(a^{d}−1) may be used.

The database management apparatus may include a query reception unit (e.g., the query reception unit 111) and a query execution unit (e.g., the query execution unit 113). The query reception unit 111 may receive a query (e.g., the query 403), and the query execution unit may read/write data from/to a database according to the query. For example, in data placement in the database, data may be placed in a segment, and a value range of the segment may be described in a range index (e.g., range index 142). In executing the query, the query execution unit may identify a segment in which a value designated in the query is present from the range index, and read only the segment in which the value designated in the query is present. In other words, the query execution unit may omit reading of a segment in which the value designated in the query is not present. In this manner, improvement of data reading performance is expected.

The multidimensional sorting unit may send a data write request (e.g., a data write query) to the query execution unit for data placement (placement of data in the input data) according to a multidimensional sorting result. The query execution unit may perform data placement in the database according to the multidimensional sorting result in accordance with the request.

In addition to Hilbert sorting, Z sorting (sorting according to Z order) may be used as multidimensional sorting. The value of the base a may be 3 or other values according to the multidimensional sorting algorithm.

Furthermore, one database management apparatus does not necessarily have to include the query reception unit and the query execution unit in addition to the integer value conversion unit and the multidimensional sorting unit. That is, a database management apparatus including the integer value conversion unit and the multidimensional sorting unit and a database management apparatus including the query reception unit and the query execution unit may be separate.

1. A database management apparatus comprising an integer value conversion unit and a multidimensional sorting unit,
wherein, for each column in input data having a plurality of columns, the integer value conversion unit
constructs a hierarchical histogram of data distribution with respect to the column by repeating division into a prescribed number of areas based on a degree and a base suitable for a multidimensional sorting algorithm and creation of an equal-width histogram as long as an empty bin is present in a histogram, and
creates integer value conversion data that maps a value range width of data in the input data to a converted integer value on the basis of the hierarchical histogram, and
wherein the multidimensional sorting unit
places the data, which is in the input data, in a database from which data is read in units of segment by multidimensionally sorting the input data according to the multidimensional sorting algorithm on the basis of the integer value conversion data of each column.

2. The database management apparatus according to claim 1, wherein, for each of the columns,
the converted integer value is a bin id of any bin in the hierarchical histogram of the column,
the integer value conversion unit assigns bin ids of bins in the hierarchical histogram equally in a range equal to or greater than a first integer value and equal to or smaller than a second integer value, and
the first integer value is a predetermined integer value, and
the second integer value is based on the base and a given degree of the column.

3. The database management apparatus according to claim 1, wherein, for each of the columns,
(A) when there is an area j related to the column and having a degree of 1 or more, the integer value conversion unit creates an equal-width histogram by dividing the area j into X equal parts with respect to the area j, X being the base \hat{ }, the degree of the area j,
(B) the integer value conversion unit determines whether there is an empty bin in the equal-width histogram,
(C) when a result of determination in (B) is true,
(c1) the integer value conversion unit divides the equal-width histogram into a plurality of areas j′ by removing empty bins from the equal-width histogram, each of the plurality of areas j′ being composed of one or more consecutive bins in which data is present,
(c2) the integer value conversion unit reduces, for each of the plurality of areas j′, a degree of the area j′ from a degree of the original area j of the area j′, and then performs (A) on each area j′ as the area j.

4. The database management apparatus according to claim 3, wherein, in (c1),
the integer value conversion unit determines whether the number of areas j′ is the n-th power of the base (n is an integer equal to or greater than 1 and equal to or less than the degree of the original area j of the areas j′) (c11), and
when the number of areas j′ is the n-th power of the base, for each of the plurality of areas j′, the integer value conversion unit reduces the degree of the area j′ by n from the degree of the original area j of the area j′ in (c2).

5. The database management apparatus according to claim 4, wherein, when the number of areas j′ is not the n-th power of the base, the integer value conversion unit further divides an area j′ with the largest area width into two equal areas j′ and performs (c11).

6. The database management apparatus according to claim 3, wherein, for each of the columns,
(D) when the result of determination in (B) is false, the integer value conversion unit
(d1) allocates equal integers in the range equal to or greater than 0 and equal to or smaller than the base\hat{ }(the degree of the area j−1) as bin ids to a plurality of bins in the equal-width histogram, and
(d2) changes the degree of the area j to 0.

7. The database management apparatus according to claim 6, wherein, for each of the columns, when degrees of all areas j related to the column are 0 or less, the integer value conversion unit updates a bin id of a bin in the hierarchical histogram of the column to a value obtained by combining bin ids in an area including the bin, in order, from a bin id of a higher tier that has the original area of the bin in a-ary notation, and converting the combined value to a decimal value.

8. The database management apparatus according to claim 3, wherein, when there is an empty area in the hierarchical histogram, the integer value conversion unit adjusts a value range width of each bin in the hierarchical histogram such that the empty area disappears.

9. The database management apparatus according to claim 1, wherein, for each of the columns,
the integer value conversion unit obtains sampling data by randomly extracting data from the input data,
the hierarchical histogram of data distribution with respect to the column is a histogram created from the sampling data, and
the number of pieces of data randomly extracted is based on the degree of the column.

10. A database management method performing by using a computer;
for each column in input data having a plurality of columns,
constructing a hierarchical histogram of data distribution with respect to the column by repeating division into a prescribed number of areas based on a degree and a base suitable for a multidimensional sorting algorithm and creation of an equal-width histogram as long as an empty bin is present in a histogram;
creating integer value conversion data that maps a value range width of data in the input data to a converted integer value on the basis of the hierarchical histogram; and
placing the data, which is in the input data, in a database from which data is read in units of segment by multidimensionally sorting the input data according to the multidimensional sorting algorithm on the basis of the integer value conversion data of each of the columns.
